(19) United States
(12) Patent Application Publication
(10) Pub. No.: US 2010/0002842 A1
(43) Pub. Date: Jan. 7, 2010

(54) CATHODE ASSEMBLY FOR RAPID ELECTRON SOURCE REPLACEMENT IN A ROTATING ANODE X-RAY GENERATOR

(75) Inventors: Gijsbertus J. Kerpershoek, Barendrecht (NL); Leendert J. Seijbel, Rotterdam (NL); Chuji Katayama, Aichi (JP)

Correspondence Address: LAW OFFICES OF PAUL E. KUDIRKA, 40 BROAD STREET, SUITE 300, BOSTON, MA, 02109, US

(73) Assignee: BRUKER AXS, INC., Madison, WI (US)

(21) Appl. No.: 12/165,863

(22) Filed: Jul. 1, 2008

(51) Int. Cl. H01J 35/06; H01J 35/00

(52) U.S. Cl. 378/125; 378/136

(57) ABSTRACT

A cathode assembly for a rotating anode X-ray source comprises two parts: a focusing part that is mechanically connected to the remainder of the X-ray source and permanently aligned with respect to the anode and a separate emission part that holds the electron source and is removably connected to the focusing part. The electron source is permanently mounted in the emission part and precisely aligned to the focusing part. The focusing part and the emission part are mechanically connected aligned relative to one another at the time of replacement. This arrangement allows the emission part, including the electron source to be quickly removed and replaced by an inexperienced user while maintaining the accuracy of the X-ray source alignment.

### BACKGROUND

This invention relates to extending the useful lifetimes of cathodes used in X-ray sources. In conventional X-ray sources, X-rays are created by directing an electron beam onto a target anode. In accordance with the well-known process of creating and filling of holes in the electron structure of the anode material, specific monochromatic X-rays are thereby created.

A typical X-ray generator comprises a cathode and an anode. The anode can be rotating, such as those used in rotating anode generators or can be stationary such as those used in sealed tubes. The cathode and the anode are located in an evacuated chamber. The cathode comprises an electron source for electron emission and additionally, in some cases, a cup or focus cup that modifies the electric field lines to focus the electrons in a well defined spot on the anode. A power supply generates a heating current, if a filament is used as an electron emitter, or power for another type of electron emitter and a high voltage (typical 30-70 kilovolts) between the electron source and anode. Due to the electron source at the cathode and the high voltage between the cathode and the anode, electrons are generated at the cathode and accelerated to the anode. In rotating anode systems, the anode typically rotates with a speed of a few thousand revolutions per minute in order to spread the heat generated when the electrons strike the anode over a large surface of the anode.

The electron sources used in X-ray generators may be filaments made of tungsten wire or other emitters, such as LaB6 crystals. Such an electron source has a lifetime that depends on the conditions of operation and normally varies between two weeks and several months. If the electron source fails in a sealed X-ray tube, then the entire tube must be replaced. It is possible to replace electron sources in a rotating anode X-ray generator because the vacuum chamber can be opened. However, reducing the time that is required to change the electron source is important in order to reduce the downtime of the X-ray generator when the electron source must be replaced.

The time that is required to change an electron source depends not only on the time required to physically replace the source, but also on the time required to realign the X-ray generator and possibly the X-ray system that utilizes the generator. In particular, due to the focusing effect that is produced at the cathode by the focus cup, small changes in the position of the electron source relative to the anode produce movements of the electron spot on the anode. These movements in turn, may require the entire system to be re-aligned. In modern X-ray diffraction systems, X-ray optics are positioned between the X-ray generator and a sample, such as a crystal, a thin film or a powder. The X-ray optics select X-rays generated at the anode and direct the selected X-rays to the sample. If the spot position on the anode changes, the setting of the optics may also need to change thereby increasing the time required to replace the filament. Consequently, the cathode must be accurately mounted with respect to the anode in order to reduce the time required for alignment.

Some conventional X-ray sources require that the entire cathode assembly, which includes the electron source, a focus cup and a housing, be mechanically removed from the remainder of the X-ray source in order to replace a failed electron source. Once the cathode assembly is removed, the electron source can be replaced. Alternatively, the entire cathode assembly can be replaced. The cathode assembly must then be reattached to the remainder of the X-ray system.

Other conventional X-ray sources require that the cathode assembly be disassembled in order to access the electron source. Once the cathode assembly is disassembled, the electron source can be removed and replaced. For example, European patent EP0273162 B1 describes a two-piece cathode cup which allows the focusing portion of the cathode cup to be removed to facilitate access to a filament.

However, in these prior art sources, a problem arises in that it is difficult to maintain the precise alignment of the electron source to the rest of the X-ray source when the cathode assembly is mechanically reattached or the electron source is replaced. Consequently, an alignment of the X-ray source and system is inevitably necessary.

### SUMMARY

In accordance with the principles of the invention, the cathode assembly comprises two parts: a focusing part that is mechanically connected to the remainder of the X-ray source and permanently aligned with respect to the anode and a separate emission part that holds the electron source and is removably connected to the focusing part. The electron source is permanently mounted in the emission part and precisely aligned to the focusing part at the time of manufacture by specialists and the focusing part and the emission part are mechanically aligned relative to one another at the time of replacement. This arrangement allows the emission part, including the electron source to be quickly removed and replaced by an inexperienced user while maintaining the accuracy of the X-ray source alignment.

In one embodiment, the focusing part and the emission part are aligned by alignment structures on the emission part that mate with corresponding alignment structures on the focusing part. In a related embodiment, the alignment structures are rims and grooves.

In another embodiment, the focusing part and the emission part are mechanically connected together by a screw.

In still another embodiment, the electron source in the emission part can be positioned to act as a point or a line source for the electrons.

### BRIEF DESCRIPTION OF THE DRAWINGS

FIG. 1 is a block schematic view of a conventional rotating anode X-ray generation apparatus.

FIG. 2 is a partial cutaway schematic drawing of a conventional focusing cup.

FIG. 3 is a perspective drawing illustrating the connection of the focus cup to the X-ray source apparatus in a conventional X-ray source.

FIG. 4 is a partial cutaway schematic diagram of a two part focusing cup constructed in accordance with the principles of the invention.

FIG. 5 is a perspective diagram of the focusing cup shown in FIG. 4.

FIG. 6 is a perspective drawing illustrating the connection of the inventive focus cup to conventional X-ray source apparatus.

FIG. 7 is a schematic diagram illustrating the demagnification of the electron beam produced by the focusing cup and the resulting demagnification of any misalignment between the focusing part and the emission part of the inventive focus cup.

FIGS. 8A-8F show possible positions of the electron source in the emitter part. These positions can vary in lateral direction, in height and with the type of focus required.

### DETAILED DESCRIPTION

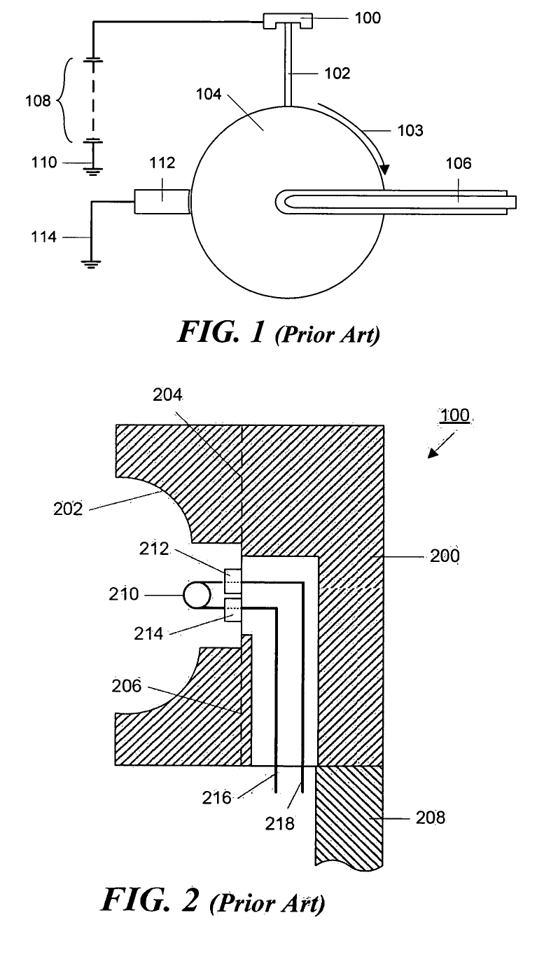

A typical rotating anode X-ray generation apparatus is illustrated in FIG. 1. In such an apparatus, a cathode 100 sprays a focused electron beam 102 onto a “thin shell” metal anode 104 that is rotating in the direction of arrow 103 in order to spread the heat load. The anode 104 is arranged as a liquid-sealed unit and a cooling fluid, generally water, is introduced into, and removed from, the interior of the metal anode 104 through coaxial tubing 106 to remove the produced heat. The cooling fluid is in direct contact with the anode material at its interior surfaces. A high-voltage generator 108 is normally connected between the cathode 100 and ground 110. The high voltage circuit is completed using a carbon brush 112 which is grounded at 114 and which bears against the rotating anode 104.

FIG. 2 shows a cutaway detail of a conventional focusing cup 100. The focusing cup 100 comprises a housing 200 which may have an integral focusing portion 202 or (as indicated schematically by dotted lines 204 and 206) the focusing portion 202 may be removable to facilitate access to the electron source 210. In FIG. 2, the electron source is shown as a filament 210, although, as mentioned above other conventional electron sources can also be used. If a filament 210 is used, the ends of the filament 210 can be plugged into insulating sockets 212 and 214 that are permanently attached to housing 200. The sockets 212 and 214 are, in turn, connected to wires 216 and 218 that connect the filament 210 to an energizing power source (not shown in FIG. 2).

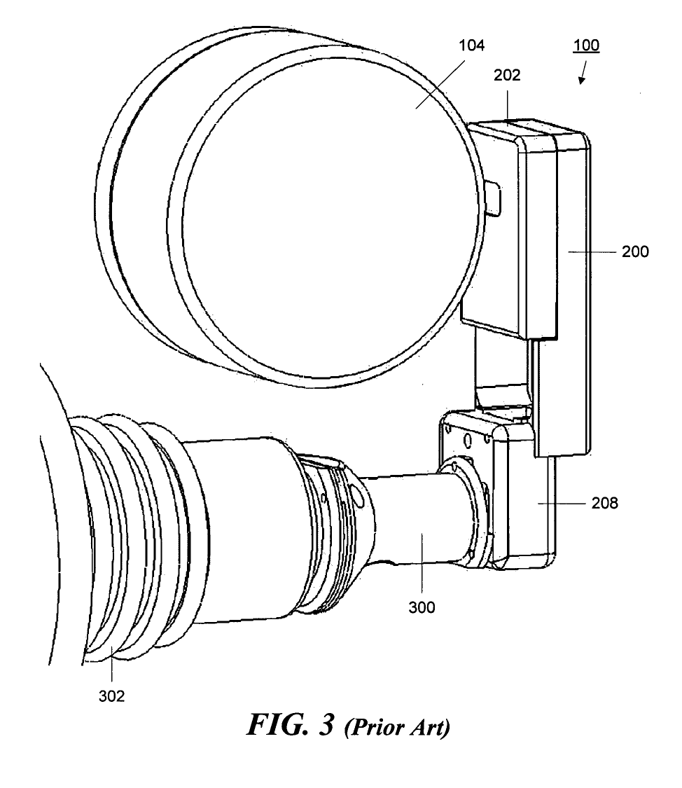

In conventional focusing cups, a housing 200 with the permanently attached electron source 210 is mechanically connected by a fitting 208 to the apparatus on which the anode is mounted. This arrangement is shown in more detail in FIG. 3. Here the focusing cup 100 is shown with the housing 200 mounted on a fitting 208 attached to an arm 300. Arm 300 is connected to the vacuum chamber via the high voltage insulator 302 in order to have a firm connection relative to the anode 104 while isolating the high voltage of the cathode. For purposes of clarity, the motor that rotates the anode 104 and its supporting structure have been omitted from FIG. 3.

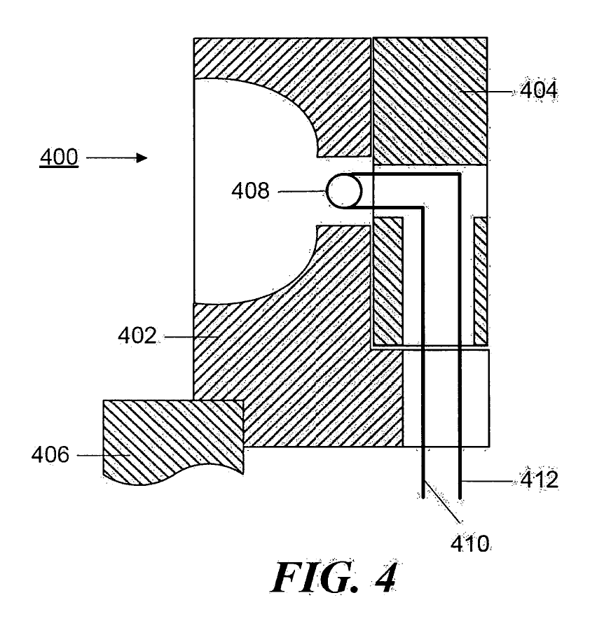

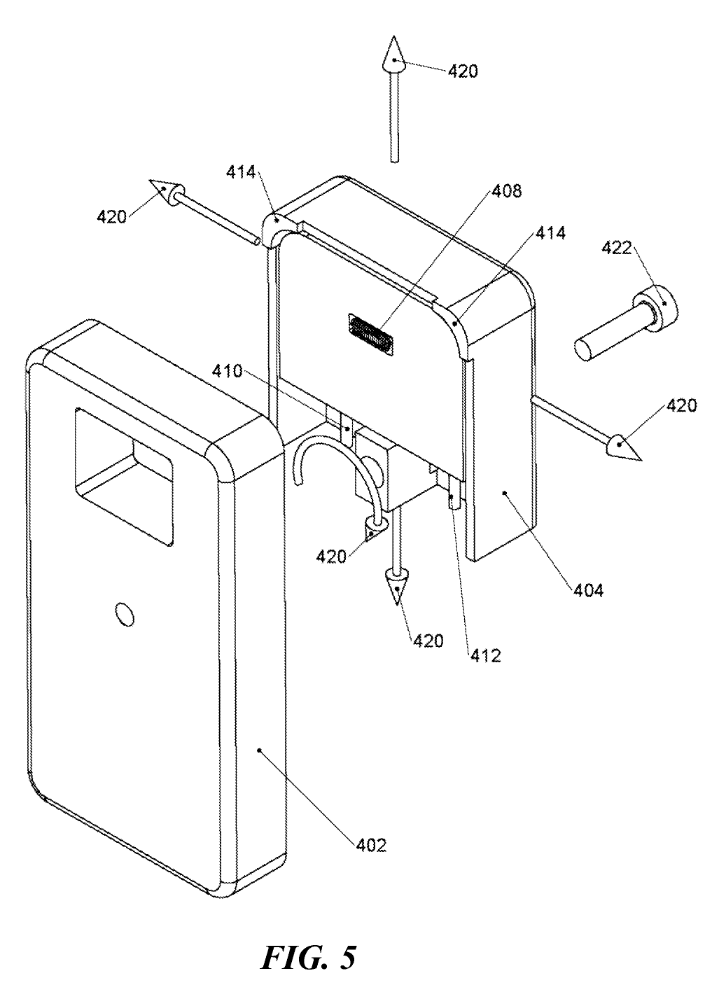

In accordance with the principles of the invention, a focusing cup structure has a focusing part permanently mounted with respect to the anode and a removable emission part containing the electron source. FIG. 4 shows a schematic partial cutaway view and FIG. 5 shows a perspective view of a focusing cup structure 400 comprised of a focusing part 402 (simplified for purposes of illustration) and an emission part 404. The emission part 404 contains an electron source 406, which in FIGS. 4, 5 and 8 is shown as a filament. However, as mentioned above, other electron sources may also be used. The emission part 404 also contains the connections 410 and 412 that connect the electron source to an excitation power supply (not shown in FIGS. 4 and 5).

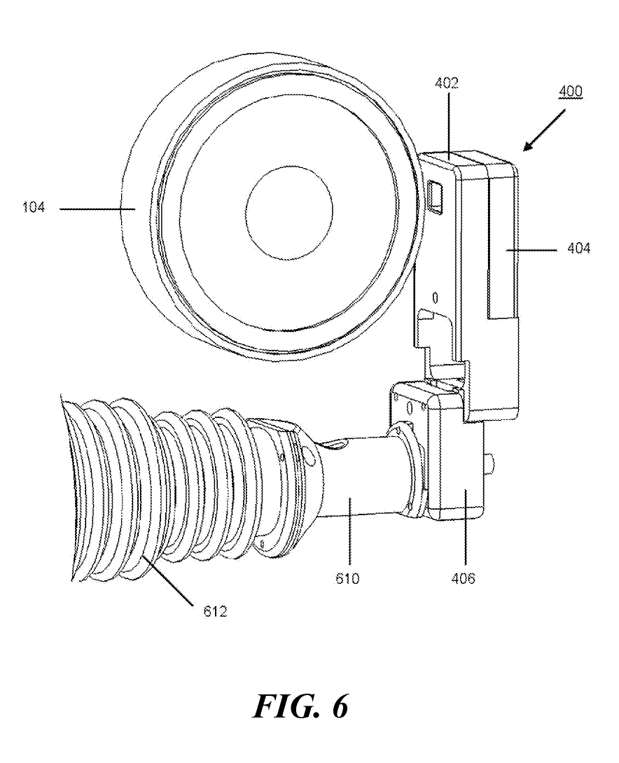

The focusing part 402 of the focusing cup structure is permanently connected to the X-ray source apparatus as schematically illustrated as part 406 in FIG. 4 and in more detail in FIG. 6. In particular, as shown in FIG. 6, the focusing part 402 is mounted on a fitting 408, which is in turn, connected to an arm 610. Arm 610 is connected to the vacuum chamber via the high voltage insulator 612 in order to have a firm connection relative to the anode 104 while isolating the high voltage of the cathode. As with FIG. 3, for purposes of clarity, the motor that rotates the anode 104 and its supporting structure have been omitted from FIG. 6.

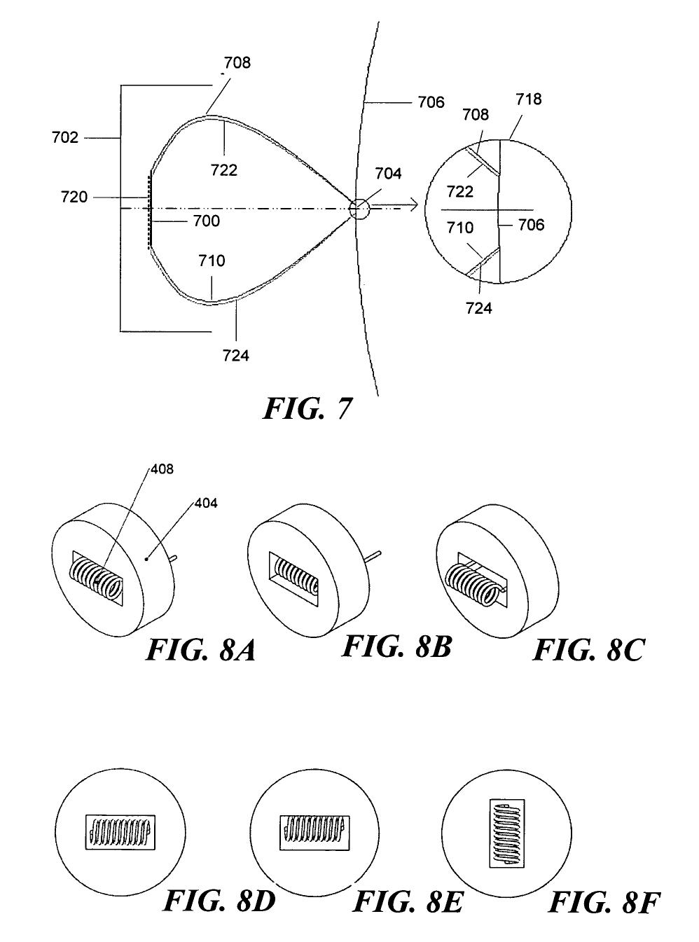

Emission part 404 can be mounted on focusing part 402 by a single screw 422 or by another simple fastening system. While it is very important to position the electron beam spot accurately on the anode in order to maintain alignment of the X-ray optics, the accuracy of the relative position of the emission part 404 with respect to the focusing part 402 is less important since, in general, the image of the electron source on the anode is de-magnified (typically 20 times) by the action of the focusing part 402 on the electron beam and, accordingly, the positioning error is reduced with the same demagnification factor. This is illustrated in FIG. 7, which shows electron trajectories in an X-ray source. In particular, electrons from an electron source 700 are focused onto a spot 704 on the anode surface 706 by the focusing cup 702. Lines 708 and 710 illustrate typical electron trajectories for electrons emitted from the ends of the electron source. These electron trajectories are focused on the anode spot 704 by the action of the focusing cup 702. An enlarged view 718 of the anode spot shows the electron trajectories 708 and 710 striking the anode surface 706.

If the electron source is shifted, for example, to the position 720, then the electron trajectories will also shift. Lines 722 and 724 show the new electron trajectories taken by electrons emitted from the end of the electron source 720. As indicated in the enlarged view 718, the new electron trajectories, 722 and 724, shift only a small distance due to the demagnification caused by the focusing part 402. Therefore, visual inspection of the alignment of part 404 with 402 (FIG. 6) is in most cases sufficient, extra alignment structures, such as rims 414 on part 404 (FIG. 5), can help the inexperienced user position the parts in order to make mounting easier. These rims fit into grooves on the back of the other part 402 (not shown in FIG. 5) and can prevent relative displacement of the emission part 404 in the directions indicated by arrows 420.

FIGS. 8A-8F show how the electron emitter 408 can be mounted in the emitter part 404. This mounting must be done accurately and can be done by a professional. Various ways to mount the electron emitter are shown. In FIG. 8A, the emitter 408 is positioned in the center of the emitter part 404. Other positions can be deeper in the emitter part (FIG. 8B) or less deep (FIG. 8C). Also, in the lateral position, the emitter can be positioned in the center (FIG. 8D), but also with a carefully selected offset (FIG. 8E). All possible combinations of this positioning can be chosen. Most of the figures in this application show emitters for a point focus setup. But it is clear that the invention can as good be used for line focus as illustrated in FIG. 8F.

While the invention has been shown and described with reference to a number of embodiments thereof, it will be recognized by those skilled in the art that various changes in form and detail may be made herein without departing from the spirit and scope of the invention as defined by the appended claims.

What is claimed is:

1. A cathode assembly that allows rapid replacement of an electron source which generates electrons that are directed to a rotating anode in an X-ray source while maintaining alignment of the electron source and the anode, the cathode assembly comprising:
a focusing part having a structure for focusing the electrons generated by the electron source and directing the electrons to the anode, the focusing part being mounted on the X-ray generator and aligned with the anode; and
an emission part having the electron source permanently mounted therein; and
a fastener that removably attaches the emission part to the focusing part so that the emission part is aligned with the focusing part thereby aligning the electron source with the anode.

2. The cathode assembly of claim 1 wherein the focusing part includes a focus electrode positioned about the electron source when the emission part is attached to the focusing part.

3. The cathode assembly of claim 2 wherein the focus electrode is shaped to produce a de-magnification of the electron source at the anode.

4. The cathode assembly of claim 1 wherein the emission part and the focusing part have alignment structures thereon which mate to mechanically align the emission part and the focusing part.

5. The cathode assembly of claim 4 wherein the alignment structures are rims and grooves.

6. The cathode assembly of claim 1 wherein the fastener is a screw.

7. The cathode assembly of claim 1 wherein the electron source is mounted in the emission part in an orientation so that the electron source acts a point source for electrons that are directed to the rotating anode.

8. The cathode assembly of claim 1 wherein the electron source is mounted in the emission part in an orientation so that the electron source acts a line source for electrons that are directed to the rotating anode.

9. An X-ray source comprising:
a rotating anode;
a cathode assembly having,
a focusing part having a structure for focusing the electrons generated by the electron source and directing the electrons to the anode, the focusing part being mounted on the X-ray generator and aligned with the anode; and
an emission part having the electron source permanently mounted therein; and
a fastener that removably attaches the emission part to the focusing part so that the emission part is aligned with the focusing part thereby aligning the electron source with the anode; and
a voltage supply for producing a potential between the anode and the cathode assembly.

10. The X-ray source of claim 9 wherein the focusing part includes a focus electrode positioned about the electron source when the emission part is attached to the focusing part.

11. The X-ray source of claim 10 wherein the focus electrode is shaped to produce a de-magnification of the electron source at the anode.

12. The X-ray source of claim 9 wherein the emission part and the focusing part have alignment structures thereon which mate to mechanically align the emission part and the focusing part.

13. The X-ray source of claim 12 wherein the alignment structures are rims and grooves.

14. The X-ray source of claim 9 wherein the fastener is a screw.

15. The X-ray source of claim 9 wherein the electron source is mounted in the emission part in an orientation so that the electron source acts a point source for electrons that are directed to the rotating anode.

16. The X-ray source of claim 9 wherein the electron source is mounted in the emission part in an orientation so that the electron source acts a line source for electrons that are directed to the rotating anode.

17. A cathode assembly that allows rapid replacement of an electron source which generates electrons that are directed to a rotating anode in an X-ray source while maintaining alignment of the electron source and the anode, the cathode assembly comprising:
a focusing part having means for focusing the electrons generated by the electron source and means for directing the electrons to the anode, the focusing part being mounted on the X-ray generator and aligned with the anode; and
an emission part having means for generating electrons permanently mounted therein; and
means for removably attaching the emission part to the focusing part so that the emission part is aligned with the focusing part thereby aligning the electron source with the anode.

18. The cathode assembly of claim 17 wherein the emission part and the focusing part have alignment structures thereon which mate to mechanically align the emission part and the focusing part.

19. The cathode assembly of claim 18 wherein the alignment structures are rims and grooves.
